(19) United States
(12) Patent Application Publication
(10) Pub. No.: US 2013/0063658 A1
(43) Pub. Date: Mar. 14, 2013

(54) VADIO-VIDEO RADIO

(71) Applicants: Robert B. Clemmer, Sacramento, CA (US); Elliot A. Swan, Keizer, OR (US); Mathew D. Polzin, Portland, OR (US); Sam O. Oluwalana, Salt Lake City, UT (US)

(72) Inventors: Robert B. Clemmer, Sacramento, CA (US); Elliot A. Swan, Keizer, OR (US); Mathew D. Polzin, Portland, OR (US); Sam O. Oluwalana, Salt Lake City, UT (US)

(21) Appl. No.: 13/279,024

(22) Filed: Oct. 21, 2011

Related U.S. Application Data
(60) Provisional application No. 61/533,028, filed on Sep. 9, 2011.
(60) Provisional application No. 61/533,034, filed on Sep. 9, 2011.

(51) Int. Cl. H04N 9/475

(52) U.S. Cl. 348/515; 348/E09.034

(57) ABSTRACT

Embodiments of the invention relate to a system, method, computer product, computer system and device for providing a live broadcast, the method includes receiving a first audio content; determining a first video content that matches the first audio content; matching the first video content with the first audio content in real time, forming matched first audio/video content; and providing the matched first audio/video content in the live broadcast. The method further includes receiving a second audio content; determining a second video content that matches the second audio content; matching the second video content with the second audio content in real time, forming matched second audio/video content; and providing the matched second audio/video content in the live broadcast.

### CLAIM FOR PRIORITY

This application claims priority from U.S. Provisional Application Ser. No. 61/533,028 filed Sep. 9, 2011 titled “Vadio-Video Radio” and U.S. Provisional Application Ser. No. 61/533,034 filed Sep. 9, 2011 titled “Vadio-Video Live Video Stream Radio”, the complete subject matter of each of which is incorporated herein by reference in its entirety.

### FIELD OF THE INVENTION

The invention relates to a system, method, computer product, computer system and device for providing video and audio broadcasts. More particularly, embodiments relate to a system, method, computer product and computer system for matching and/or matching video and audio content in a live video/audio broadcast stream.

### BACKGROUND OF THE INVENTION

Known audio broadcasts, whether broadcast over the air (radio or satellite broadcasts) or over the internet, may include video. However, such known broadcasts generally providing a predetermined video playlist that bears little or no relation to the audio broadcast.

One skilled in the art would recognize that it is difficult to match live on-air audio broadcasts (music and songs) with video. This is especially true as various music and songs have different play lengths. Further the music and songs may be interrupted as a DJ changes the song, talks or airs a commercial. For the foregoing reasons, there is a need for a system, method, computer product, computer system and device for providing video and audio broadcasts, where video content is seamlessly matched and/or synced with the live on-air music or songs.

### SUMMARY OF THE INVENTION

One embodiment relates to a method for providing a live broadcast, the method includes receiving a first audio content; determining a first video content that matches the first audio content; matching the first video content with the first audio content in real time, forming matched first audio/video content; and providing the matched first audio/video content in the live broadcast. The method further includes receiving a second audio content; determining a second video content that matches the second audio content; matching the second video content with the second audio content in real time, forming matched second audio/video content; and providing the matched second audio/video content in the live broadcast.

Another embodiment relates to a computer program product including a computer readable medium having computer readable instructions for providing a live broadcast, the computer readable instructions configured to receive a first audio content; determine a first video content that matches the first audio content; match the first video content with the first audio content in real time, forming matched first audio/video content; and provide the matched first audio/video content in the live broadcast. The computer readable instructions are further configured to receive a second audio content; determine a second video content that matches the second audio content; match the second video content with the second audio content in real time, forming matched second audio/video content; and provide the matched second audio/video content in the live broadcast.

Yet another embodiment relates to a computer system including one or more server devices to provide a live broadcast, at least one of the server devices configured to receive a first audio content; determine a first video content that matches the first audio content; match the first video content with the first audio content in real time, forming matched first audio/video content; and provide the matched first audio/video content in the live broadcast. The at least one server device is further configured to receive a second audio content; determine a second video content that matches the second audio content; match the second video content with the second audio content in real time, forming matched second audio/video content; and provide the matched second audio/video content in the live broadcast.

Still another embodiment relates to a device including one or more memories configured to store a plurality of video content and one or more processors operably coupled to the one or more memories and configured to receive a first audio content; determine a first video content from the plurality of video content that matches the first audio content; match the first video content with the first audio content in real time, forming matched first audio/video content; and provide the matched first audio/video content in the live broadcast. At least one of the processors is further configured to receive a second audio content; determine a second video content from the plurality of video content that matches the second audio content; match the second video content with the second audio content in real time, forming matched second audio/video content; and provide the matched second audio/video content in the live broadcast.

One other embodiment relates to a method for providing a live broadcast, the method including receiving a first audio content; determining a first video content that matches the first audio content; matching the first video content with the first audio content in real time, forming matched first audio/video content; and providing the matched first audio/video content in the live broadcast. The method further includes receiving a second audio content; determining a second video content that matches the second audio content; matching the second video content with the second audio content in real time, forming matched second audio/video content; queuing the matched second audio/video content; tracking the matched first audio/video content in the live broadcast; and providing the matched second audio/video content after the broadcast of the matched first audio/video in the live broadcast is completed.

Within the radio industry, a “wired” network is a network that delivers commercials at pre-set times on a pre-determined list of radio stations. This is in contrast with an “unwired” network which delivers commercials to a pre-determined list of radio stations but allows each individual radio station to determine when it will broadcast the commercials.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### BRIEF DESCRIPTION OF THE SEVERAL VIEWS OF THE DRAWINGS

FIG. 1 depicts a high level view of a system for matching audio and video and providing a live content in accordance with one embodiment of the present invention;

FIG. 2 depicts a website provided by the system of FIG. 1;

FIGS. 3A and 3B depict a high level flow chart illustrates a method matching audio and video and providing a live broadcast using the system of FIG. 1;

Throughout the various figures, like reference numbers refer to like elements.

### DETAILED DESCRIPTION OF PRESENTLY PREFERRED EMBODIMENTS

Embodiments of the present invention relate to a system, method, computer product, and computer system and device for providing video and audio broadcasts, where video content is seamlessly matched and/or synced with the live on-air music or songs. Embodiments make radio, along with any other audio, more engaging and marketable. This technology enables artists, radio stations, and record labels to match and/or sync the video content to the audio content. One or more embodiments matches and/or syncs video with audio being played on a radio station broadcast or an internet audio stream. In at least one embodiment, video content is cut off or paused immediately when the audio content is changed or stopped, by a dj for example. In another embodiment, the audio content is tracked by placing them in a queue. This enables the music videos to be played in full form which still being matched and/or synced with the audio. In at least one embodiment, the matched or synched audio video broadcast is controlled by the length of the audio content, while in at least one other embodiment, the matched or synched audio video broadcast is controlled by the length of the video content.

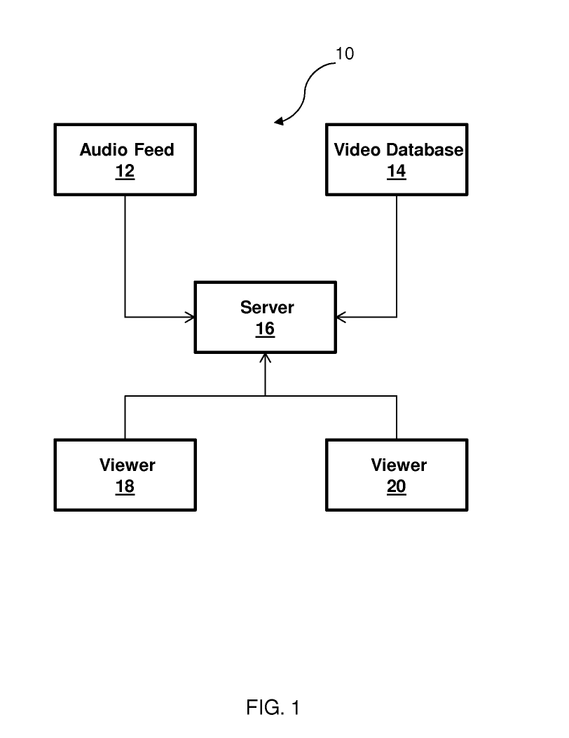

FIG. 1 is a high level view of a system, generally designated 10, for matching audio and video and providing a live content in accordance with one embodiment of the present invention. System 10 includes one or more server devices 16 providing a live broadcast to listeners/viewers 18 and 20. The server device 16 is configured to receive one or more audio content 12, a first audio content for example. The server device 16 accesses video storage device/database 14, and determines at least one video content, a first video content for example, that matches the first audio content. It should be appreciated that, while the video storage device/database 14 is illustrated as a separate, stand alone device, embodiments are contemplated in which the storage device/database 14 is incorporated into the one or more server devices 16.

Server device 16 matches and/or syncs the first video content with the first audio content in real time, forming matched first audio/video content; and provides the matched first audio/video content in the live broadcast to the one or more listener/viewers 18 and 20. While not shown, it is contemplated that the listener/viewers may receive the broadcast on any device, including PC's, cable TVs, PDA's, cell phones, automobile radios, portable radio, and the like.

The server device 16 is further configured to receive one or more audio content 12, a second audio content for example. The server device 16 accesses video storage device/database 14, and determines at least one video content, a second video content for example, that matches the second audio content. Server device 16 matches and/or syncs the second video content with the second audio content in real time, forming matched second audio/video content; and provides the matched second audio/video content in the live broadcast to the one or more listener/viewers 18 and 20. While only first and second audio, first and second video, matched first audio/video content and matched second audio/video content are discussed, any number of audio, video, and matched audio/video content are contemplated.

Embodiments of the computer system 10 further include interrupting the provided matched first audio/video content in the live broadcast to provide the matched second audio/video content in the live broadcast. The computer system 10 may include providing the live broadcast over the air or on an internet based stream. Embodiments of the computer system 10 further include queuing the matched second audio/video content, where the matched first audio/video content in the live broadcast is tracked and providing the queued matched second audio/video content after the matched first audio/video is broadcast in the live broadcast.

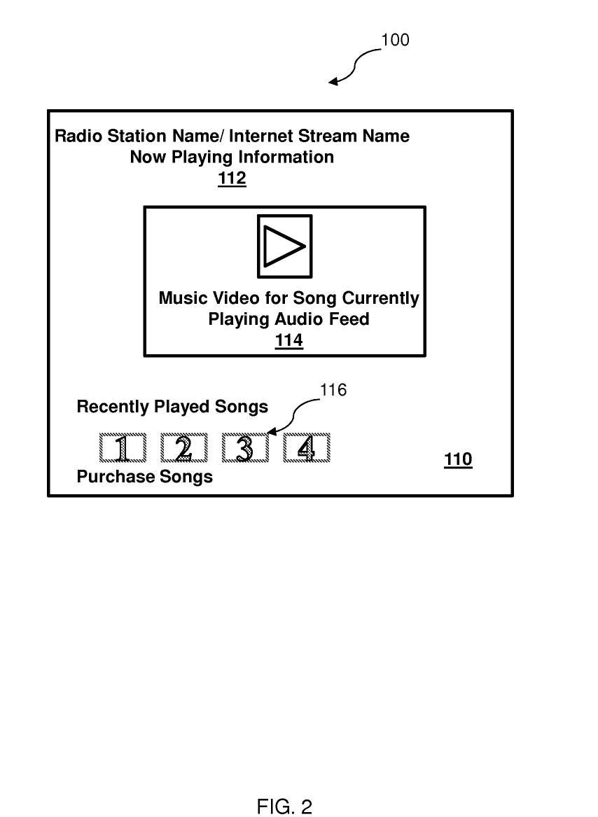

FIG. 2 depicts a website, generally designated 100, provided by the system 10 of FIG. 1 for example. Website 100 includes a screen portion 110 including an ID portion 112 that identifies the radio station/internet stream name. Screen portion 110 further includes media player portion 114 that provides the music video for song currently playing audio feed. In at least one embodiment, website 100 further includes one or more selection buttons 116 that identify recently played songs, and allows the listener/viewer to purchase such recently played songs.

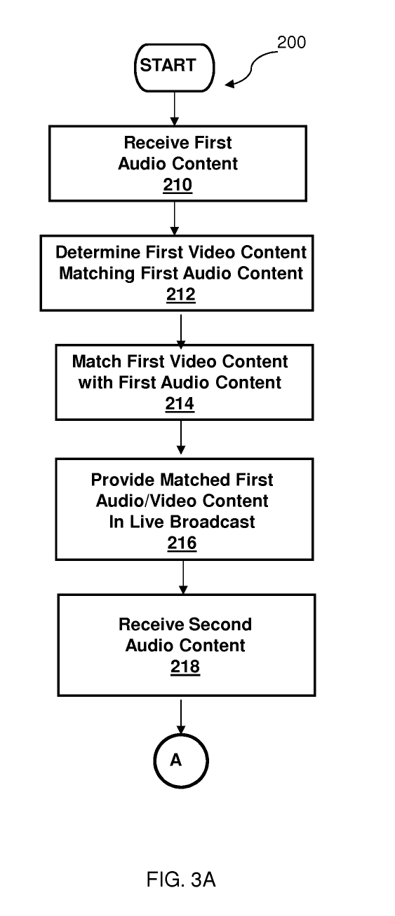

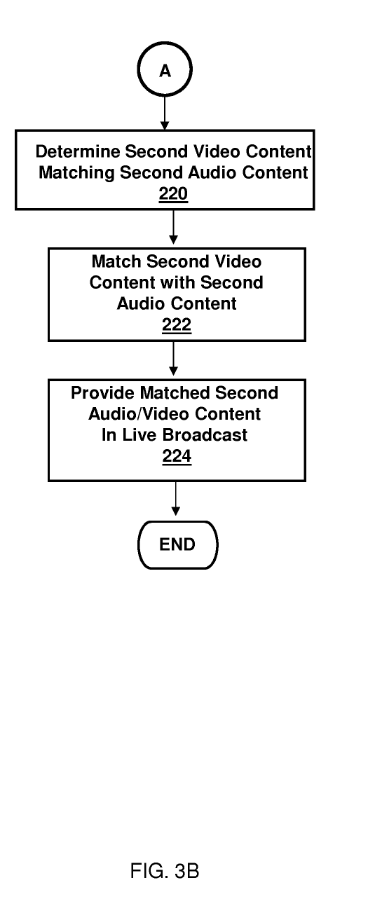

FIGS. 3A and 3B depict a high level flow chart illustrating a method, generally designed 200, for matching audio and video and providing a live broadcast using the system of FIG. 1 for example. The method 200 includes receiving one or more audio content, a first audio content for example, block 210. Method 200 determine one or more video content, a first video content for example, that matches and/or syncs with the first audio content, block 212; and matches the first video content with the first audio content in real time, forming a matched first audio/video content, block 214. The method 200 provides the matched first audio/video content in the live broadcast, block 216.

In at least one embodiment, the method 200 further includes receiving one or more audio content, a second audio content for example, block 218, and determines one or more video content, a second video content for example, that matches and/or syncs with the second audio content, block 220, in real time, forming matched second audio/video content, block 222. The matched second audio/video content is provided in the live broadcast, block 224.

Embodiments of the method 200 further include interrupting the provided matched first audio/video content in the live broadcast to provide the matched second audio/video content in the live broadcast. The method 200 may include providing the live broadcast over the air or on an internet based stream. Embodiments of the method 200 further include queuing the matched second audio/video content, where the matched first audio/video content in the live broadcast is tracked and providing the queued matched second audio/video content after the matched first audio/video is broadcast in the live broadcast.

Still another embodiment relates to a device including one or more memory devices configured to store a plurality of video content and one or more processors operably coupled to the one or more memories. The one or more processors are configured to receive one or more audio content, a first audio content for example; determine at least one video content, first video content for example, from the plurality of video content that matches the first audio content; match and/or sync the first video content with the first audio content in real time, forming matched first audio/video content; and provide the matched first audio/video content in the live broadcast. The one or more processors are further configured to receive one or more audio content, a first audio content for example; determine at least one video content, a second video content for example, from the plurality of video content that matches the second audio content; match and/or sync the second video content with the second audio content in real time, forming matched second audio/video content; and provide the matched second audio/video content in the live broadcast.

Embodiments of the device further include interrupting the provided matched first audio/video content in the live broadcast to provide the matched second audio/video content in the live broadcast. The device may include providing the live broadcast over the air or on an internet based stream. Embodiments of the device further include queuing the matched second audio/video content, where the matched first audio/video content in the live broadcast is tracked and providing the queued matched second audio/video content after the matched first audio/video is broadcast in the live broadcast.

One or more embodiments relate to a computer program product including a computer readable medium having computer readable instructions for providing a live broadcast. The computer readable instructions are configured to receive one or more audio content, a first audio content for example; determine at least one video content, a first video content for example, that matches the first audio content; match and/or synch the first video content with the first audio content in real time, forming matched first audio/video content and provide the matched first audio/video content in the live broadcast. The computer readable instructions are further configured to receive one or more audio content, a second audio content for example; determine at least one video content, a second video content for example, that matches the second audio content; match and/or sync the second video content with the second audio content in real time, forming matched second audio/video content; and provide the matched second audio/video content in the live broadcast.

Embodiments of the computer program product further include interrupting the provided matched first audio/video content in the live broadcast to provide the matched second audio/video content in the live broadcast. The computer program product may include providing the live broadcast over the air or on an internet based stream. Embodiments of the computer program product further include queuing the matched second audio/video content, where the matched first audio/video content in the live broadcast is tracked and providing the queued matched second audio/video content after the matched first audio/video is broadcast in the live broadcast.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A method for providing a live broadcast, the method comprising:
receiving a first audio content;
determining a first video content that matches the first audio content;
matching the first video content with the first audio content in real time, forming matched first audio/video content;
providing the matched first audio/video content in the live broadcast;
receiving a second audio content;
determining a second video content that matches the second audio content;
matching the second video content with the second audio content in real time, forming matched second audio/video content; and
providing the matched second audio/video content in the live broadcast.

2. The method of claim 1 further comprising interrupting the provided matched first audio/video content in the live broadcast to provide the matched second audio/video content in the live broadcast.

3. The method of claim 1 further comprising providing the live broadcast over the air or on an internet based stream.

4. The method of claim 1 further comprising queuing the matched second audio/video content.

5. The method of claim 4 further comprising tracking the matched first audio/video content in the live broadcast and providing the queued matched second audio/video content after the matched first audio/video is broadcast in the live broadcast.

6. A computer program product comprising:
a computer readable medium having computer readable instructions for providing a live broadcast, the computer readable instructions configured to:
receive a first audio content;
determine a first video content that matches the first audio content;
match the first video content with the first audio content in real time, forming matched first audio/video content;
provide the matched first audio/video content in the live broadcast;
receive a second audio content;
determine a second video content that matches the second audio content;
match the second video content with the second audio content in real time, forming matched second audio/video content; and
provide the matched second audio/video content in the live broadcast.

7. The product of claim 6 further comprising interrupting providing the matched first audio/video content in the live broadcast to provide the matched second audio/video content in the live broadcast.

8. The product of claim 6 further comprising providing the live broadcast over the air or on an internet based stream.

9. The product of claim 6 further comprising queuing the matched second audio/video content.

10. The product of claim 9 further comprising tracking the matched first audio/video content in the live broadcast and providing the queued matched second audio/video content after the matched first audio/video is broadcast in the live broadcast.

11. A computer system comprising:
one or more server devices to provide a live broadcast, the server device configured to:
receive a first audio content;
determine a first video content that matches the first audio content;
match the first video content with the first audio content in real time, forming matched first audio/video content;
provide the matched first audio/video content in the live broadcast;
receive a second audio content;
determine a second video content that matches the second audio content;
match the second video content with the second audio content in real time, forming matched second audio/video content; and
provide the matched second audio/video content in the live broadcast.

12. The system of claim 11 further comprising interrupting the provided matched first audio/video content in the live broadcast to provide the matched second audio/video content in the live broadcast.

13. The system of claim 11 further comprising providing the live broadcast over the air or on an internet based stream.

14. The system of claim 11 further comprising queuing the matched second audio/video content.

15. The system of claim 14 further comprising tracking the matched first audio/video content in the live broadcast and providing the queued matched second audio/video content after the matched first audio/video is broadcast in the live broadcast.

16. A device comprising:
one or more memories configured to store a plurality of video content;
one or more processors operably coupled to the one or more memories and configured to:
receive a first audio content;
determine a first video content from the plurality of video content that matches the first audio content;
match the first video content with the first audio content in real time, forming matched first audio/video content;
provide the matched first audio/video content in the live broadcast;
receive a second audio content;
determine a second video content from the plurality of video content that matches the second audio content;
match the second video content with the second audio content in real time, forming matched second audio/video content; and
provide the matched second audio/video content in the live broadcast.

17. The device of claim 16 further comprising interrupting the provided matched first audio/video content in the live broadcast to provide the matched second audio/video content in the live broadcast.

18. The device of claim 16 further comprising providing the live broadcast over the air or on an internet based stream.

19. The device of claim 16 further comprising queuing the matched second audio/video content.

20. The device of claim 19 further comprising tracking the matched first audio/video content in the live broadcast and providing the queued matched second audio/video content after the matched first audio/video is broadcast in the live broadcast.

21. A method for providing a live broadcast, the method comprising:
receiving a first audio content;
determining a first video content that matches the first audio content;
matching the first video content with the first audio content in real time, forming matched first audio/video content;
providing the matched first audio/video content in the live broadcast;
receiving a second audio content;
determining a second video content that matches the second audio content;
matching the second video content with the second audio content in real time, forming matched second audio/video content;
queuing the matched second audio/video content;
tracking the matched first audio/video content in the live broadcast; and
providing the matched second audio/video content after the matched first audio/video is broadcast in the live broadcast.
